(19) United States
(12) Patent Application Publication
(10) Pub. No.: US 2010/0268525 A1
(43) Pub. Date: Oct. 21, 2010

(54) REAL TIME TRANSLATION SYSTEM AND METHOD FOR MOBILE PHONE CONTENTS

(75) Inventors: Seong-Soo Kim, Seoul (KR); Ju-Sun Park, Gyeonggi-do (KR)

Correspondence Address: SCULLY SCOTT MURPHY & PRESSER, PC, 400 GARDEN CITY PLAZA, SUITE 300, GARDEN CITY, NY, 11530, US

(73) Assignee: SEO-O TELECOM CO., LTD., Seoul (KR)

(21) Appl. No.: 12/669,641

(22) PCT Filed: Jul. 17, 2008
(86) PCT No.: PCT/KR08/04184

§ 371 Date: Jun. 28, 2010

(30) Foreign Application Priority Data
Jul. 19, 2007 (KR) 10-2007-0072181

(51) Int. Cl. G06F 17/28

(52) U.S. Cl. 704/2; 704/E17.001

(57) ABSTRACT

The present invention relates to real time translation system and method for mobile phone contents that include a mobile phone providing an embedded translation menu installed in an operation system and a basic service program and a contents translation menu provided from CP, a gateway routing a material to be translated that is received through an interface interlocking with an SMS server of a mobile communication company when translation is requested from the embedded translation menu of the mobile phone, routing specific ID information of the material to be translated that is received through a WAP server of contents provider when translation is requested through the contents translation menu of the mobile phone, a web server of contents provider routing the material to be translated that is matched with the specific ID transmitted from the gateway, a translation server translating the material transmitted from the interface of the gateway or the web server of CP and producing translated results.

### TECHNICAL FIELD

The present invention relates to real time translation system and method for mobile phone contents.

### BACKGROUND ART

Recently, technologies to translate web sites or data on the web sites on an internet have been widely developed and commercialized. For a typical example, the portal search site such as Google provides translation service for a page searched in real time or a page that a user accesses to.

In addition, conventional SMS-based mobile phones for transmitting simple messages have been improved to provide various types of messaging services such as multimedia messaging service (MMS). Accordingly, demand for real time translation service has been increased.

In addition, multilingual messaging service and use thereof are increased according to opened mobile phone communication network and globalization of business. Accordingly, various demands about the services will be more increased.

In the Korean Patent Publication No. 10-2004-0011889 titled “A method for providing a user interface for multi languages and mobile phone realizing the same”, there is disclosed a mobile phone including a controller processing data that are suitable for a corresponding language when the specific language is selected through a multilingual user interface to allow a user to select and set the language, a keypad equipped with a selection button for selecting many languages and a key button for composing a message, a display unit providing a menu screen for allowing a mobile phone user to select a corresponding language and a result screen displayed by the selected language to the mobile phone user, a memory unit storing menu data processed to use a multilingual user interface, multilingual string data that correspond to a menu and font data in many languages that correspond to the string data, an audio converter outputting analogue voice through a speaker by processing data received from the outside and transmitting digital data to the controller by converting the analogue voice inputted from a microphone into the digital data and a wireless circuit unit receiving a phone call or a character message transmitted from an external phone and transmitting them to the controller.

In other words, in the conventional mobile phones, menu data for supporting the multilingual support service should be additionally provided in the mobile phone.

Accordingly, the conventional construction of the mobile phone cannot provide the multilingual support service.

Particularly, there have been following problems. Memory capacity is increased because the translation service is possible in a state that string data of languages and font data of languages corresponding to the string data have been stored in the memory of the mobile phone. The service is possible for only a language selected by the user but the multilingual translation service is impossible for SMS character messages, text or various contents.

### DISCLOSURE OF THE INVENTION

### Technical Problem

Accordingly, an object of the present invention is to provide real time translation service system and method that can translate materials such as SMS character messages, texts and various contents by interlocking with an SMS server of a mobile communication company and a server of contents provider and provide the translated materials to a mobile phone.

### Technical Solution

According to an aspect of the present invention, there is provided a real time translation system for mobile phone contents, which includes: a mobile phone providing an embedded translation menu installed in an operation system and a basic service program and a contents translation menu provided from a contents provider (CP); a gateway, routing a material to be translated that is received through an interface interlocked with an SMS service of a mobile communication company when translation is requested through the embedded translation menu of the mobile phone, routing specific ID information of the translation material received through a contents provider wireless application protocol (WAP) when translation is requested through the contents translation menu of the mobile phone; a web server of contents provider routing the material matched with a specific ID transmitted from the gateway; and a translation server, translating the material transmitted from the interface of the gateway or the material transmitted from the web sever of contents provider in real time, producing translated results.

The mobile phone may include a translation icon formed on a keypad or a display screen in order to provide translation service by using the embedded translation menu or the contents translation menu.

The interface of the gateway may convert the result received from the translation sever into a form requested from the mobile phone and send the converted result to the mobile phone.

The WAP server of contents provider of the gateway may receive the result translated from the translation server through the web server of contents provider, convert the result into a form requested from the mobile phone, and send the result to the mobile phone.

The translation server may include a grapheme/character/context recognition unit recognizing grapheme/character/context by analyzing a language requested for translation from a user terminal in a unit of token, a translation processing unit performing translation according to the grapheme/character/context that are recognized by the grapheme/character/context recognition unit and a translation result producing unit producing a final translation result translated from the translation processing unit according to the grapheme/character/context.

According to an aspect of the present invention, there is provided a real time translation method for mobile phone contents, which includes: (a) requesting translation if a material to be translated using a translation menu provided from the mobile phone; (b) determining whether the request for translation from the mobile phone is transmitted through an embedded translation menu of the mobile phone or a contents translation menu provided from a contents provider; (c) routing the material received through an interface interlocking with an SMS server of a mobile communication company when the request is received through the embedded translation menu of the mobile phone and routing the material matched with a specific ID of the material received through a WAP server of contents provider when the request is received the contents translation menu provided from the contents provider; and (d) producing a translation result by translation the material the material routed through the interface or matched with the specific ID in real time.

The method may further include converting the material routed through the interface or the translation result for the material matched with the specific ID into a form requested from the mobile phone and sending the translation result to the mobile phone.

The step (d) may include recognizing analyzed grapheme/character/context by analyzing a language of the translation material routed through the interface or matched with the specific ID in a unit of token; performing translation according to the recognized grapheme/character/context; and producing a final translation result translated according to the grapheme/character/context.

### Advantageous Effects

According to the present invention, the real time translation system and method for mobile phone contents produce the following effects.

First, the system and method provide the most efficient translation service for data communication and transaction using a mobile phone and decision making through messages by translation materials such as SMS character messages, texts and various contents in real time due to interlocking with an SMS server of a mobile communication company and a server of contents provider and thereby providing the translated materials to the mobile phone.

Second, the system and method provide a WAP service interface and filter server interface of the mobile communication company messaging server so as to translate contents in various types. Accordingly, the mobile communication company and contents providers of the mobile communication company can provide contents addition service and contents translation service.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating the construction of a real time translation system for mobile phone contents;

FIG. 2 is a diagram illustrating an example of a real time translation request screen in a user terminal of FIG. 1; and

FIG. 3 is a diagram illustrating a real time translation method for mobile phone contents according to the present invention.

### EXPLANATION ON REFERENCE NUMERALS OF MAIN ELEMENTS IN THE DRAWINGS

10: User terminal

20: Communication interface server (G/W)

21: Mobile communication company interface unit

22: WAP server of mobile contents provider

30: SMS server of mobile communication company

40: Web-based CP server

50: CP communication server

60: Translation server

61: grapheme/character/context recognition unit

62: Translation processing unit

63: Translation result producing unit

### BEST MODE FOR CARRYING OUT THE INVENTION

Hereinafter, preferred embodiments of the present invention will be described in detail with reference to the accompanying drawing. The aspect and features of the present invention and methods for achieving the aspects and features will be apparent by referring to the embodiments to be described in detail with reference to the accompanying drawings. The matters defined in the description, such as the detailed construction and elements, are nothing but specific detail provided to assist those of ordinary skill in the art in a comprehensive understanding of the invention, and the present invention is only defined within the scope of the appended claims. In the entire description of the present invention, the same drawing reference numerals are used for the same elements across various figures.

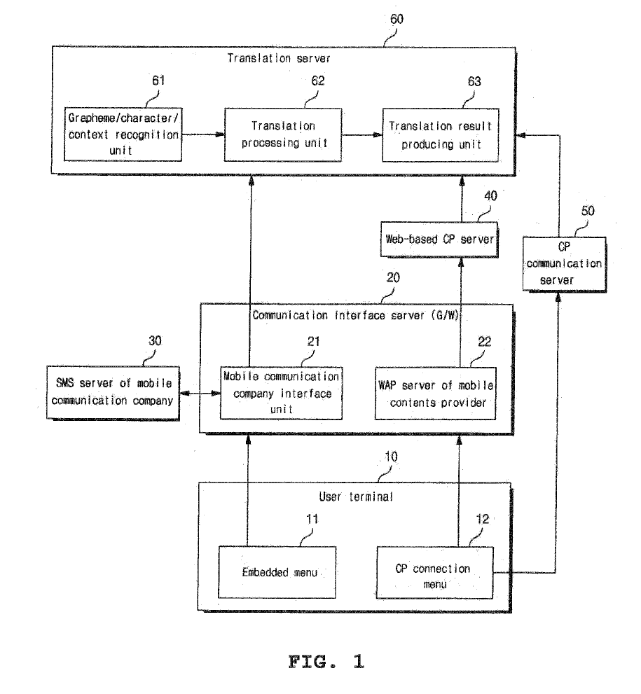

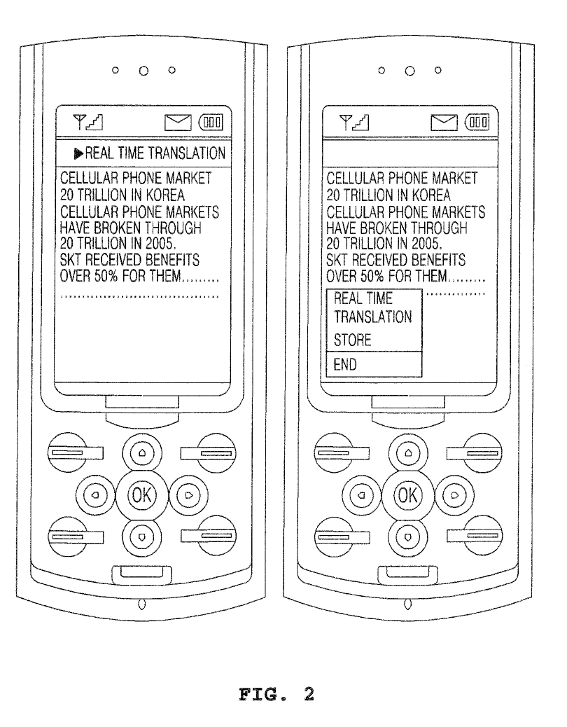

FIG. 1 is a diagram illustrating the construction of a real time translation system for mobile phone contents according to the present invention. FIG. 2 is a diagram illustrating an example of a real time translation request screen in a user terminal of FIG. 1.

Referring to FIG. 1, the real time translation system includes a user terminal 10, a communication interface server (gateway) 20, an SMS server of a mobile communication company 30, a web-based CP server 40, a CP communication server 50 and a translation server 60.

The user terminal 10 is a terminal of a general mobile phone. The user terminal can be used through an embedded menu 11 of a mobile phone by adding translation service function to an operation system and a basic service program. A user requests translation service for SMS character messages, texts or contents to be transmitted and received using a translation menu function of the embedded menu 11 and receives the service.

The user terminal 10 can be used through a CP connection menu 12 of the mobile phone for using a translation menu function according to internet-based contents that are provided at any time from contents providers. Additionally, the user receives the translation service for texts and contents using the translation menu function of the CP connection menu 12.

When the user request the translation service using the translation menu function of the embedded menu 11 or the CP connection menu 12 of the user terminal 10, a translation icon is additionally formed on a keypad of a terminal or a display screen so as to allow the user to receive the translation service for SMS character messages, texts or contents immediately when clicking the translation icon.

Particularly, the user can request the translation by designating a predetermined region of the character messages, the texts or the contents with a cursor and selecting a necessary portion when making a request for translation service using the translation menu function such as the embedded menu 11 or the CP connection menu 12.

The communication interface server (gateway) 20 includes a mobile communication company interface unit 21 to interlock with the SMS server of the mobile communication company 30 and a WAP server of mobile CP 22 to interlock with the web-based CP server 40.

The mobile communication company interface unit 21 is interlocked with a call of the SMS server of mobile communication company 30 and sends SMS character messages or other contents that are requested for translation from the user terminal 10 to the translation server 60 when the user requests translation of the SMS character messages or other contents to be translated to the SMS server of the mobile communication company 30 by selecting the translation function menu from the embedded menu 11 of the user terminal 10.

The WAP server of mobile CP 22 is interlocked with the web-based CP server 40 and transmits texts or other contents requested for translation to the web-based CP server 40 from the user terminal 10 when the user request translation of the texts or the contents by selecting the translation function from the CP connection menu 12 of the user terminal 10.

The web-based CP server 40 is a server for providing texts or contents to the user terminal 10 and each of texts or contents that are provided to the user terminal 10 is equipped with the respective specific ID. In addition, the server 40 recognizes the specific IDs for the texts or contents that are requested for translation from the user terminal 10 and transmits corresponding texts or contents that are matched with the IDs to the translation server 60.

The communication server of CP 50 is a server using a WAP and it can be directly communicated with the user terminal 10. Additionally, the server 50 receives texts or contents that are requested for translation and requests translation to the translation server 60 when the translation is requested by using the CP connection menu 12 of the user terminal 10.

The translation server 60 performs translation for the corresponding SMS character messages or other contents that are transmitted through the mobile communication company interface unit 21 of the communication interface server (gateway) 20 according to the request from the user terminal 10. Additionally, the server 60 performs translation for the corresponding texts or contents that are transmitted through the WAP server of mobile CP 22 of the communication interface server (gateway) 20 and the web-based CP server 40 according to request for translation from the user terminal 10.

Additionally, the translation server 60 performs translation for corresponding texts or contents that are transmitted through the communication server of CP 50 according to request for translation from the user terminal 10.

The translation server 60 processes SMS character messages, texts or contents that are transmitted from the user terminal 10 to be recognized by classifying the character messages, texts or contents into grapheme and morpheme and translates the corresponding contents automatically in a unit of individual recognition token.

In other words, the translation server 60 provides a mutual translation function between Korean and Chinese characters in addition to multilingual translation through the translation mechanism.

The translation server 60 includes a grapheme/character/context recognition unit 61, a translation processing unit 62 and a translation result producing unit 63.

The grapheme/character/context recognition unit 61 recognizes grapheme/character/context through analysis in the unit of token for analysis of the minimum unit to translate SMS character messages, texts or contents that are requested for translation from the user terminal 10.

The token analysis of the minimum unit may be an analysis, for example, initial/central/final consonants in case of Korean, an alphabet character such as a, b, c, etc. in case of English, hiragana and katakana in case of Japanese and the minimum Chinese character in case of Chinese.

The translation processing unit 62 performs translation suitable for the grapheme/character/context recognized by the grapheme/character/context recognition unit 61.

The translation result producing unit 63 produces a final translation result according to translation result suitable for the grapheme/character/context the is performed by the translation processing unit 62.

The final translation result produced by the translation result producing unit 63 is transmitted to the user terminal 10 through different paths according to the user's requests for translation through the embedded menu 11 of the user terminal 10 and the CP connection menu 12.

In other words, when the user requests translation through the embedded menu 11 of the user terminal 10, the final translation result produced by the translation result producing unit 63 is transmitted to the mobile communication company interface unit 21.

Additionally, the mobile communication company interface unit 21 converts the final result into the same format as requested for translation from the user terminal 10 and transmits the converted result to the user terminal 10.

When the user requests translation through the CP connection menu 12 of the user terminal 10, the final translation result produced by the translation result producing unit 63 is transmitted to the WAP server of mobile CP 22 of the communication interface server(gateway) 20 through the web-based CP server 40 and the WAP server 22 converts the final translation result into the same format as requested from the user terminal 10.

For example, as shown in FIG. 2, the user selects a language (English/Japanese/Chinese/Chinese character and others) to be translated and requests translation to the translation server after selection real-time translation through the embedded menu or the CP connection menu of the user terminal displayed on a screen on which Korean contents for translation are displayed on the user terminal.

Accordingly, the translation server produces a final translation result by recognizing grapheme/character/context through analysis in the unit of token for analysis in the minimum unit to translate Korean contents that are materials for translation into a corresponding language and by performing translation suitable for the recognized grapheme/character/context.

The communication interface server converts the final translation result produced from the translation server into the same format as requested from the user terminal and then transmits the result to the user terminal.

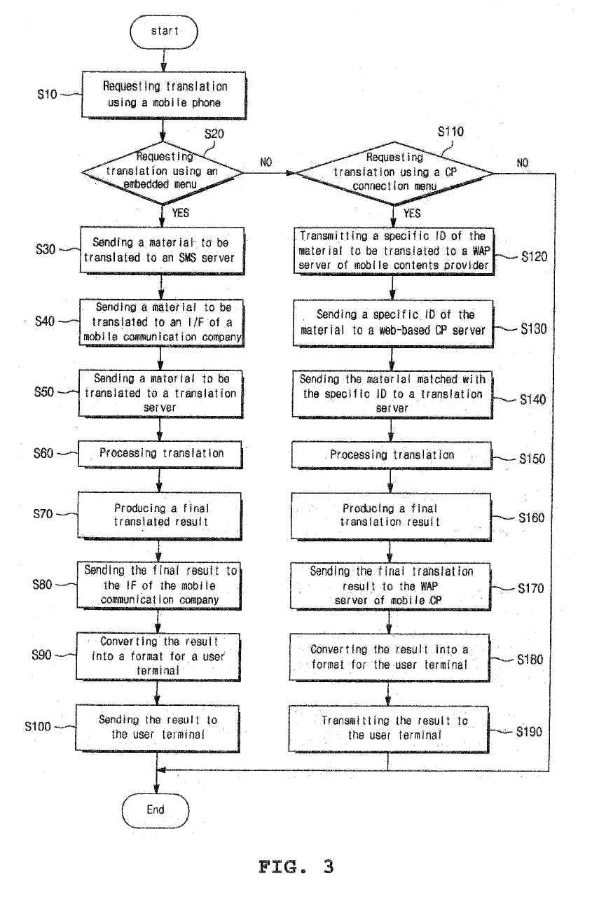

FIG. 3 is a diagram illustration a real time translation method for mobile phone contents according to the present invention.

Referring to FIG. 3, the user requests translation of a material such as SMS character messages, texts or contents using a translation request menu provided from a user terminal such as a mobile phone (S10).

Accordingly, the terminal determines whether the user requests the translation of the corresponding material using an embedded menu installed in the mobile phone (S20).

As a result of the determination, the material requested for translation is transmitted to an SMS server of a mobile communication company when the user requests the translation using a translation request menu of the embedded menu (S30).

The material transmitted to the SMS server of the mobile communication company is transmitted to a mobile communication interface unit interlocked with a call of the SMS server (S40).

The material transmitted to the interface unit is transmitted to a translation server (S50). Additionally, the translation server translates the corresponding material (S60) and produces a final translation result (S70).

In this time, the translation server processes graphemes and morphemes for translating the corresponding material to be classified and recognized and translates corresponding contents automatically according to individual recognition token.

In other words, the translation server recognizes grapheme/character/context through analysis in a unit of token for analysis in the minimum unit to translate the material and produces a final translation result by performing translate the material and produces a final translation result by performing translation suitable for the recognized grapheme/character/context.

The final translation result is transmitted the mobile communication company interface unit (S80) and converted into the same format as requested from the user terminal (S90) and then transmitted to the user terminal (S100).

In the step S20, it is determined whether the user requests translation using the CP connection menu of the user terminal when the user does not request translation using a translation request menu of the embedded menu (S110).

As a result of the determination, when the user requests translation using a translation request menu of the CP connection menu, a specific ID of the translation material selected by the user is transmitted to a WAP server of mobile CP (S120).

Next, the specific ID of the translation material sent to the WAP server of mobile CP is transmitted to a web-based CP server (S130).

Accordingly, the web-based CP server transmits translation materials such as texts or contents that are matched with the transmitted specific ID to a translation server (S140). The translation server translates the corresponding translation material (S150) and produces a final translation result (S160).

In this time, the translation server processes graphemes and morphemes for translation the corresponding materials to be classified and recognized and translates the corresponding contents automatically according to individual recognition token.

In other words, the translation server produces the final translation result by recognizing grapheme/character/context through analysis in the unit of token for analysis in the minimum unit to translate the corresponding material and performing translation suitable for the recognized grapheme/character/context.

Next, the final translation result is transmitted to the WAP server of mobile CP through the web-based CP server (S170) and converted into the same format as requested from the user terminal (S180) and then transmitted to the user terminal (S190).

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A real time translation system for mobile phone contents, comprising:
a mobile phone providing an embedded translation menu installed in an operation system and a basic service program and a contents translation menu provided from a contents provider (CP);
a gateway, routing a material to be translated that is received through an interface interlocking with an SMS server of a mobile communication company when translation is requested through the embedded translation menu of the mobile phone, routing specific ID information of a material to be translated that is received through a WAP server of CP when translation is requested through the contents translation menu of the mobile phone;
a web server of CP routing the material matched with a specific ID that is transmitted from the gateway; and
a translation server, translating the material transmitted from the interface of the gateway or transmitted from the web server of CP in real time, producing translated results.

2. The system of claim 1, wherein the mobile phone comprises a translation icon formed on a keypad or a display screen, which provides translation service using the embedded translation menu or the contents translation menu.

3. The system of claim 1, wherein the interface of the gateway converts the translation result into a form requested by the mobile phone when the result translated from the translation server is received and transmits the result to the mobile phone.

4. The system of claim 1, wherein the WAP server of CP of the gateway receives the result translated from the translation server through the web server of CP and converts the result into a form requested by the mobile phone and transmits the result to the mobile phone.

5. The system of claim 1, wherein the translation server comprises:
a grapheme/character/context recognition unit, analyzing a language of a translation material requested for translation from the user terminal in the unit of token, recognizing the analyzed grapheme/character/context;
a translation processing unit performing translation according to the grapheme/character/context recognized by the grapheme/character/context recognition unit; and
a translation result producing unit producing a final translation result translated from the translation server according to the grapheme/character/context.

6. A real time translation method for mobile phone contents, comprising:
(a) requesting translation of a material to be translated using a translation menu provided from the mobile phone;
(b) determining whether the request for translation from the mobile phone is transmitted through the embedded translation menu of the mobile or transmitted through the contents translation menu provided from the contents provider;
(c) routing the material to be translated that is received through an interface interlocking with an SMS server of a mobile communication company in case of the translation request through the embedded translation menu of the mobile phone, routing a material to be translated that is matched with a specific ID of the material received through the. WAP server of CP in case of the contents translation menu provided from the contents provider; and
(d) producing translated results by translating materials routed through the interface or matched with the specific ID.

7. The method of claim 6, further comprising:
converting the translated results routed through the interface or matched with the specific ID into a form requested from the mobile phone and sending the converted results to the mobile phone.

8. The method of claim 6, wherein the step (d) comprises:
analyzing languages of the materials to be translated that are routed through the interface or matched with the specific ID and recognizing the analyzed grapheme/character/context;
performing translation according to the recognized grapheme/character/context; and
producing a final translated result according to the grapheme/character/context.
